(19) United States
(12) Patent Application Publication
(10) Pub. No.: US 2002/0037707 A1
(43) Pub. Date: Mar. 28, 2002

(54) Emergency informing terminal and emergency informing system

(76) Inventors: Kenji Yoshioka, Kanagawa (JP); Koji Ukena, Kanagawa (JP)

Correspondence Address: RATNER AND PRESTIA, Suite 301, One Westlakes, Berwyn, P.O. Box 980, Valley Forge, PA, 19482-0980, US

(21) Appl. No.: 09/921,627

(22) Filed: Aug. 3, 2001

(30) Foreign Application Priority Data
Aug. 4, 2000 (JP) 2000-237060
Jun. 28, 2001 (JP) 2001-196788

(51) Int. Cl. H04M 11/00

(52) U.S. Cl. 455/404; 455/550; 455/569

(57) ABSTRACT

Disclose is an emergency informing terminal for making an emergency call securely, being advanced in reliability, without having to connect peripheral devices and the emergency informing terminal with connection wires. This emergency informing terminal comprises a terminal main body, and a peripheral device connected to the terminal main body and incorporated in part of the terminal main body. The peripheral device includes a microphone and a speaker for hands-free conversation. Further, the peripheral device includes an indicator for showing the operating state, an emergency informing button to be pressed by the user in case of emergency, a communication antenna for making data communication and conversation with the emergency call center, a GPS antenna for acquiring position information or time information, and a gyro sensor for detecting the vehicle direction or acceleration.

### TITLE OF THE INVENTION

Emergency informing terminal and emergency informing system

### FIELD OF THE INVENTION

The present invention relates to an emergency informing terminal and an emergency informing system. More particularly, it relates to an emergency informing terminal mounted on a vehicle for transmitting data of vehicle position information or the like to an emergency call center in the event of emergency, and an emergency informing system using the same.

### BACKGROUND OF THE INVENTION

Hitherto is known an emergency informing terminal mounted on a vehicle, including emergency informing means for making an emergency call to the center supervising the emergency informing system such as police or emergency call center (hereinafter called emergency call center) by way of a repeating base station of a communications operator or the like, for exchanging two-way data communications or two-way conversation.

A conventional emergency informing terminal includes, for example, the following peripheral devices outside of the casing for composing the emergency informing terminal main body:

a microphone and a speaker for making hands-free conversation as voice signal transmitting means;

a communication antenna for making radio communications as radio communication signal transmitting means;

an indicator for showing the operating state of the emergency informing terminal;

an emergency informing button pressed by the user for causing the terminal to start an emergency call; and

a gyro sensor and a global positioning system (GPS) antenna for locating the vehicle position.

On the other hand, the emergency informing terminal includes, in its inside, a control unit for processing various signals of information from the peripheral devices, an echo canceling circuit for hands-free conversation, a signal switching circuit for switching the communication antenna, and a memory for acquiring and storing vehicle position information, running history, etc. The emergency informing terminal main body and its peripheral devices are connected through connectors and connection wires, and signals are transmitted mutually through the connection wires.

An emergency informing terminal is used for making an emergency call to the emergency call center, in the event of traffic accident or sickness, either automatically or by a simple operation. Therefore, these peripheral devices must be used securely even in the event of an accident. Hence, various methods have been proposed for enhancing the reliability of the peripheral devices and the emergency informing terminal, and guaranteeing emergency call even in case of trouble of these peripheral devices.

As an example in consideration of trouble of peripheral device at the time of accident, Japanese Laid-open Patent No. 11-220526 discloses handsfree conversation equipment having plural speakers. In this equipment, in case of breakage of speaker, plural speakers are disposed at different positions of a vehicle, and if one speaker is broken, conversation is assured by changing over to other speaker.

Japanese Laid-open Patent No. 7-79195 discloses a vehicle accident informing device having two communication antennas connected at front and rear positions of a vehicle. This device also has an impact sensor for detecting accident. In this device, therefore, an accident is detected when an impact is applied, or when reception signal from either communication antenna becomes weaker due to breakage of either front or rear communication antenna of the vehicle. In such a case, this device functions to make an emergency call by using the communication antenna of a stronger reception signal.

In these conventional emergency informing terminals, peripheral devices are connected outside of the terminal, and they are connected to the main body by way of the connectors and connection wires. Therefore, if a traffic accident impact is applied, the connection line may be broken, though measures against impact in the peripheral devices make them hard to be out of order, and signal transmission to peripheral devices may be cut off. In such a case, an emergency call may not be processed correctly.

Besides, in the hands-free conversation equipment having plural speakers, or the accident information device having front and rear communication antennas, the number of parts is inevitably increased, such as speakers, connection wires, connectors and communication antennas. In these devices, the peripheral devices such as speakers and communication antennas are connected to the main body through connection wires, and if these wires are broken in the event of accident, the emergency informing process is cut off.

### SUMMARY OF THE INVENTION

The emergency informing terminal of the invention is mounted on a vehicle, and is designed to make an emergency call to the emergency call center in the event of an emergency. This emergency informing terminal comprises a terminal main body, and peripheral devices connected to the terminal main body and mounted in part of the terminal main body.

In such configuration, it is not necessary to connect the peripheral devices and the emergency informing terminal by connection wires, and the reliability of the emergency informing terminal is enhanced, and an emergency call is processed securely. Moreover, the number of parts such as connection wires and connectors for connecting between the peripheral devices and emergency informing terminal can be curtailed.

### BRIEF DESCRIPTION OF THE DRAWINGS

FIG. 1 is a block diagram showing a configuration of an emergency informing terminal in embodiment 1 of the invention.

FIG. 2 is a schematic diagram showing a first installation state of the emergency informing terminal in embodiment 1 of the invention.

FIG. 3 is a schematic diagram showing a second installation state of the emergency informing terminal in embodiment 1 of the invention.

FIG. 4 shows an installation state of a gyro sensor in embodiment 1 of the invention.

FIG. 5 (a) shows an installation state of gyro sensor in the casing of the emergency informing terminal in embodiment 1 of the invention.

FIG. 5 (b) shows other installation state of gyro sensor in the casing of the emergency informing terminal in embodiment 1 of the invention.

FIG. 6 (a) shows a configuration of an antenna integrating a GPS antenna and a mobile phone antenna in the emergency informing terminal in embodiment 1 of the invention.

FIG. 6 (b) shows other configuration of an antenna integrating a GPS antenna and a mobile phone antenna in the emergency informing terminal in embodiment 1 of the invention.

FIG. 7 is a block diagram showing a configuration of an emergency informing terminal in embodiment 2 of the invention.

### DESCRIPTION OF THE PREFERRED EMBODIMENTS

Referring now to the drawings, preferred embodiments of the invention are described in detail below.

Embodiment 1

In embodiment 1 of the invention, an emergency informing terminal includes peripheral devices such as a microphone, a speaker, an indicator, and an emergency informing button, and makes an emergency call to the emergency call center. This emergency informing terminal makes two-way data communications and two-way conversation with the emergency call center.

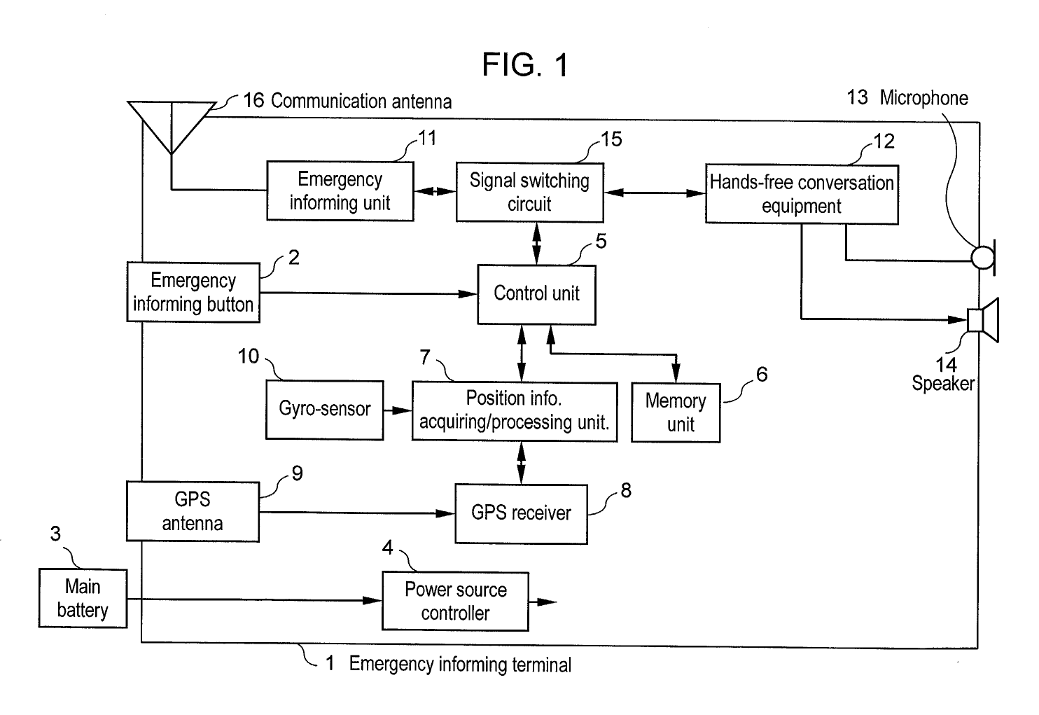

FIG. 1 is a block diagram showing a configuration of an emergency informing terminal in embodiment 1 of the invention.

The emergency informing terminal 1 is mounted on an automobile or other vehicles, and requests dispatch of an emergency vehicle in the event of emergency such as traffic accident or sickness by transmitting data such as present vehicle position and registered vehicle information to the emergency call center.

An emergency informing button 2, an example of emergency informing means, is pressed by the user in case of emergency such as traffic accident or sickness, and generates a signal for starting the above process. This button is incorporated in part of the emergency informing terminal 1.

The emergency informing terminal 1 is operated by receiving power supply in the internal circuit, through a power source controller 4 from a main battery 3, for feeding power to the electrical appliances in the vehicle.

A control unit 5 composed of microcomputer and other control circuits controls the operation of the terminal 1 depending on emergency case or nonemergency case.

The emergency informing terminal 1 further incorporates an auxiliary battery. The auxiliary battery is charged from the main battery 3. If power supply from the main battery 3 is interrupted, it is designed to support emergency call by the power supply from the auxiliary battery, so that the reliability is enhanced.

A memory unit 6 stores various items of information, including the telephone number of the emergency call center, registration number of the vehicle mounting the emergency informing terminal 1, and position information generated in a position information acquiring and processing unit 7. The memory unit 6 issues the recorded data to the control unit 5 responsive to a request signal from the control unit 5.

The position information acquiring and processing unit 7 composing part of the position information acquiring means issues the data received in a GPS receiver 8 from a GPS antenna 9, and the position information data generated from the data from a gyro sensor 10, to the control unit 5.

The GPS antenna 9, an example of position information acquiring means, is incorporated in part of the emergency informing terminal 1, and receives the position data from a GPS satellite.

It is preferred to be mounted on the surface of the emergency informing terminal so that the data from the GPS satellite may be received easily.

By the data acquired from the GPS antenna 9, the data such as position information is issued to the position information acquiring and processing unit 7. The GPS receiver 8 is connected to the GPS antenna 9 inside the emergency informing terminal.

The gyro sensor 10 is incorporated in part of the emergency informing terminal 1, and generates information such as vehicle running direction or the like.

An emergency informing unit 11 receives a transmission request signal from the control unit 5, and makes a telephone call to the partner corresponding to the telephone number, depending on the telephone number acquired from the control unit 5 or the telephone number entered from a dial operation unit not shown, through the base station of communications operator or the like. The dial operation unit is also incorporated in part of the emergency informing terminal 1.

After the telephone call process, when the emergency informing unit 11 receives a response signal from the partner or a signal transferring to talk such as busy signal, and the unit 11 transfers to the conversation control or data communication control. The emergency informing unit 11 also issues a signal transferring to conversation state to the control unit 5.

Moreover, the emergency informing unit 11 transmits the data such as vehicle running direction or position information entered from the control unit 5, to the partner or the emergency call center as the partner.

A hands-free conversation equipment 12 has a signal processing and level adjusting function, and processes the transmission voice signal from the user during conversation, and voice signal from the reception voice signal from the emergency call center, by echo canceling or housing control. Thus, the hands-free conversation during emergency informing process is realized. The hands-free conversation equipment 12 is connected to a microphone 13 and a speaker 14 as voice signal transmitting means inside the emergency informing terminal 1. The user makes hands-free conversation by using the microphone 13 and speaker 14.

The microphone 13, an example of voice signal transmitting means, is incorporated in part of the emergency informing terminal 1. The microphone 13 issues the user's voice to the emergency informing terminal 1 at the time of conversation in emergency informing process. The microphone 13 is composed as a microphone module incorporating the microphone, amplifier circuit and others.

When the microphone 13 is incorporated inside the emergency informing terminal 1, it is preferred to provide the surface of the emergency informing terminal with an opening for voice input.

The speaker 14, an example of voice signal transmitting means, is incorporated in part of the emergency informing terminal 1. The speaker 14 sounds the reception voice signal from the emergency call center at the time of conversation informing. When the speaker 14 is incorporated inside the emergency informing terminal 1, it is preferred to provide the surface of the emergency informing terminal with an opening for voice output.

A signal switching circuit 15 connects the control signal path between the emergency informing unit 11 and the control unit 5, and controls the data transmission and reception, and emergency informing unit 11. The signal switching circuit 15 further changes over the input and output voice signal of the emergency informing unit 11, either to the control unit 5 or to the handsfree conversation equipment 12.

A communication antenna 16 which is radio communication signal transmitting means for data communication and voice signal communication is incorporated in part of the emergency informing terminal 1. As the antenna, rod antenna, whip antenna, flexible antenna, and microstrip antenna can be combined. The communication antenna 16 relays the transmission signal from the emergency informing unit 11 through the repeater base station of the communications operator, and transmits the signal to the emergency call center. The antenna 16 issues also the reception signal from the emergency call center to the emergency informing unit 11.

The communication antenna 16 may be also composed of a primary antenna for transmission and reception, and a secondary antenna for reception only. In this case, a diversity system may be employed, that is, usually the primary antenna is used for transmission and reception, and the reception is changed over to the secondary antenna depending on the quality of the reception state.

All of them are incorporated in part of the emergency informing terminal 1, and wired within the terminal.

In the emergency informing terminal 1 in embodiment 1 having such configuration, the operation is explained below.

In the emergency informing terminal 1 of the invention, usually aside from emergency informing process, the position information acquiring and processing unit 7 is generating position information data from the data from the gyro sensor 10 and the data received from the GPS antenna 9 in the GPS receiver 8.

The control unit 5 periodically acquires the position information and other data from the position information acquiring and processing unit 7, and records in the memory unit 6.

Once a traffic accident, sickness or other emergency occurs, the emergency informing button 2, an example of emergency informing means, is pressed by the user. As mentioned above, the emergency informing button 2 is incorporated in part of the emergency informing terminal 1. Therefore, disconnection by impact of accident is prevented, and the pushing signal is securely issued to the control unit 5. The control unit 5, receiving this signal, recognizes request of emergency call, and starts emergency informing process.

In succession, the control unit 5 instructs the signal switching circuit 15 to connect the signal path of the emergency informing unit 11 and control unit 5.

Further, the control unit 5 acquires the position information and other data stored in the memory unit 6, and the telephone number of the emergency call center, and requests a telephone call to the emergency informing unit 11 by using the telephone number.

A telephone call may be also requested from a dial operation unit, not shown, which is an example of dial operating means.

As mentioned above, since the dial operation unit, not shown, is incorporated in part of the emergency informing terminal 1, disconnection due to impact of accident is prevented, and a telephone call is processed securely.

The control unit 5 also processes to acquire position information and history data recorded in the memory unit 6.

The GPS antenna 9 and gyro sensor 10 are incorporated in part of the emergency informing terminal 1. Similarly, disconnection due to impact of accident is prevented, and the latest position information is securely acquired.

Further, the emergency informing unit 11 receives the telephone call request, and starts telephone call process to the partner corresponding to the telephone number through the base station of the communications operator by using the communication antenna 16. When the emergency informing unit 11 receives a response signal from the partner, or a signal transferring to conversation such as busy signal, and recognizes transfer to conversation state. At this time, the emergency informing unit 11 transfers to conversation control or data communication control, and issues a signal telling transfer to talk to the control unit 5.

As a result, the control unit 5 judges the talk is successful, and transmits the position data and other data acquired from the memory unit 6 to the emergency call center through the base station of communications operator. Since the communication antenna 16 is incorporated in part of the emergency informing terminal 1, disconnection due to impact of accident is prevented, and the data transmission process and conversation process can be done securely.

When the emergency call center receives all of position information data and history data from the emergency informing terminal 1,the center changes over to the conversation process.

The emergency informing unit 11 in the emergency informing terminal 1 receives a signal showing transfer to conversation, and issues a signal telling transfer to conversation to the control unit 5. Receiving this signal, the control unit 5 controls the signal switching circuit 15 to connect the voice path between the emergency informing unit 11 and hands-free conversation equipment 12. Later, the control unit 5 transfers to conversation process.

After transfer to conversation process, the emergency informing unit 11 issues the reception voice signal from the emergency call center to the hands-free conversation equipment 12.

At this time, using the internal signal processing circuit, the handsfree conversation equipment 12 acquires the voice level and frequency characteristic from the reception voice signal, and raises the voice level of the reception voice signal, and issues the voice signal to the speaker 14.

The speaker 14 sounds the reception voice signal entered from the hands-free conversation equipment 12, and transmits the signal to the user.

The microphone 13 acquires the voice signal from the user, and the reception voice signal sounded from the speaker 14.

The hands-free conversation equipment 12, when receiving the transmission signal having the same signal components as the voice level and frequency characteristic acquired from the reception voice signal, judges that the receiving signals are echo components of the reception voice signal entered from the microphone 13. At this time, the hands-free conversation equipment 12 processes to remove echo component, and issues the processed signal to the emergency informing unit 11.

The emergency informing unit 11 receives the transmission voice signal from the hands-free conversation equipment 12, and transmits it to the emergency call center.

As described above, the microphone 13 and speaker 14 are incorporated in part of the emergency informing terminal 1. Hence, disconnection due to impact of accident is prevented, and the hands-free conversation is processed securely.

The transmission antenna 16 guarantees secure radio communications by the same reason.

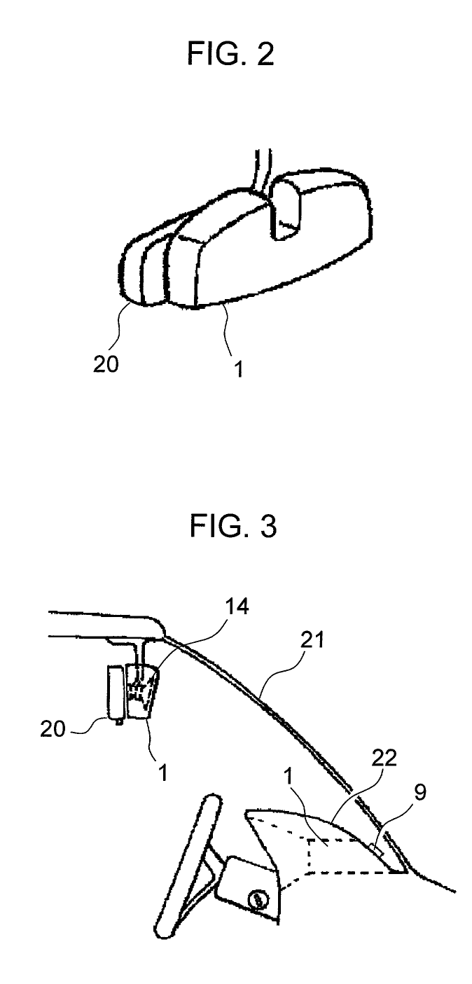

FIG. 2 and FIG. 3 are first and second conceptual diagrams showing the state of installation of the emergency informing terminal in the embodiment.

The emergency informing terminal 1 of the invention incorporates almost all functions necessary for emergency call in its own casing. Therefore, the direction of installation is free but the GPS antenna 9 may not sufficiently receive the position information signal from the GPS satellite depending on the direction of installation. Accordingly, as shown in FIG. 2, the emergency informing terminal 1 is fixed in contact with the back side of a rearview mirror 20. Accordingly, the GPS antenna 9 is placed at a position close to the windshield 21. In this mode of installation, the position information signal from the GPS satellite is received in the car.

The speaker 14 is incorporated in the emergency informing terminal 1 as shown in FIG. 3, and the output direction of the speaker 14 is disposed to direct toward the windshield 21.

Although not shown in FIG. 2 and FIG. 3, the microphone 13 is positioned in the opposite direction of the speaker 14 so as to pick up the voice of the driver easily. As the microphone 13 and speaker 14 are directed oppositely, howling echo hardly occurs. Further, by the structure of preventing transmission of vibration of the speaker 14 to the microphone 13, the resonance of the two is suppressed, and howling echo hardly occurs.

As indicated by dotted line in FIG. 3, the emergency informing terminal 1 may be also built in the dashboard 22 of the vehicle. In this case, unlike the form of the casing of the emergency informing terminal shown in FIG. 2, the GPS antenna 9 is positioned to project to the outside of the dashboard 22, and is exposed at a position close to the windshield 21. Further, with the emergency informing terminal 1 built in the dashboard 22, in order that the driver can read the indicator easily, the indicator of the emergency informing terminal 1 is arranged along with the instruments such as speedometer. This indicator shows the operating state of the emergency informing terminal by lighting device such as LED. The indicator may be also a liquid crystal display (LCD) or other display.

The indicator is an example of display means of the emergency informing terminal 1.

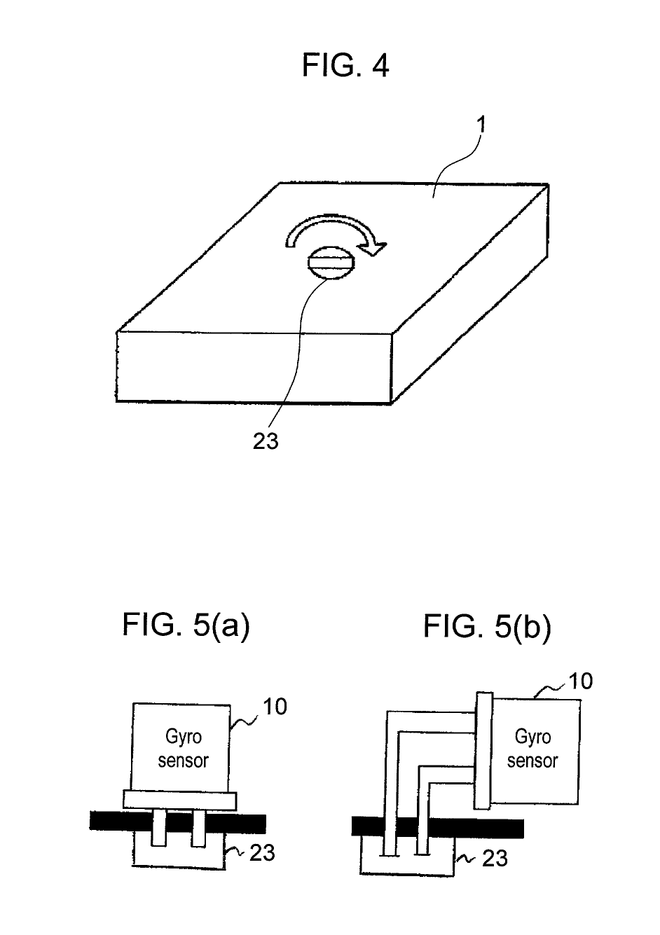

The state of installation of the gyro sensor 10 is explained in FIG. 4.

As mentioned above, the emergency informing terminal 1 of the invention may be installed in a free direction, but the output signal of the gyro sensor 10 may not be generated correctly depending on the direction of installation.

The gyro sensor 10 detects the acceleration applied to the sensor, and issues its signal. For the gyro sensor 10, there is a direction of maximum sensitivity, and the sensor output is 0 in the direction vertical to the direction of maximum sensitivity. As its countermeasure, as shown in FIG. 4, a rotary unit 23 for varying the direction of installation of the gyro sensor 10 by rotation is disposed outside of the casing of the emergency informing terminal 1. Hence, the direction of installation of the gyro sensor 10 is changed by rotation, and the maximum sensitivity is obtained.

In such configuration, installation of a higher degree of freedom is realized.

FIG. 5(a) and (b) are conceptual diagrams showing the state of installation of the gyro sensor 10 in the casing of the emergency informing terminal 1.

FIG. 5(a) is an example of mounting of the gyro sensor 10 in a vertical direction to the casing.

In this case, to couple with the rotary unit 23 provided outside the casing, a gyro sensor 10 having a vertical coupling member in the bottom is used. As a result, the gyro sensor 10 can be mounted in vertical direction.

FIG. 5(b) is an example of mounting of the gyro sensor 10 in a lateral direction to the casing.

In this case, to couple with the rotary unit 23 provided outside the casing, a gyro sensor 10 having a coupling member at an angle of 90 degrees to the bottom is used. As a result, the gyro sensor 10 can be mounted in lateral direction.

The antenna integrated structure is explained.

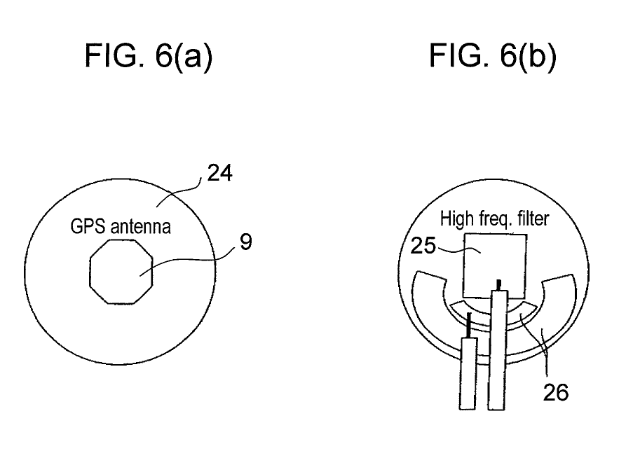

FIG. 6 shows a structure of an antenna integrating the GPS antenna 9 and mobile phone antenna.

In FIG. 6(a), an outside disk member is a substrate 24 made of glass epoxy resin, widely used in mounting of general electric circuit parts. The GPS antenna 9 is mounted in the center of the substrate 24.

On the other hand, as shown in FIG. 6(b), a high frequency filter 25 is mounted on the back side of the substrate 24. The high frequency filter 25 passes only the information acquired through the GPS antenna 9 from the GPS satellite.

The substrate 24 is made of multiple layers, and a grounding plane is formed in the entire inner layer, so that occurrence of electric interference from the back to the surface, and from the surface to the back can be prevented.

Further, as shown in FIG. 6(b), in the lower part of the back side of the substrate 24, a mobile phone antenna 26 is disposed.

The mobile phone antenna 26 has the ground on the bottom and an antenna on the top, and the antenna is composed so as to be matched with the wavelength of the transmission and reception frequency. Herein, in the same way as an ordinary antenna, the antenna 26 is designed to be matched at half wavelength or quarter wavelength.

Further, the impedance is matched with the emergency informing unit of the emergency informing terminal to be connected with the mobile phone antenna 26, or the cable to be used. As a result, the antenna structure integrating the GPS antenna and mobile phone antenna minimizing the attenuation and reflection having effects on transmission and reception of radio signals can be realized.

Thus, in this emergency informing terminal, the peripheral devices such as emergency informing button, GPS antenna, communication antenna, lighting device, display, indicator, dial operation unit, microphone and speaker used in hands-free conversation, and others are incorporated in part of the emergency informing terminal.

In the case the communication antenna is a diversity antenna composed of primary antenna and secondary antenna, the primary antenna and secondary antenna are incorporated in part of the emergency informing terminal.

Thus, it is not necessary to connect the peripheral devices and the emergency informing terminal with connection wires. As a result, the reliability of the emergency informing terminal is enhanced, and emergency call is processed securely. Moreover, the number of parts such as connection wires and connectors for connecting the peripheral devices and the emergency informing terminal can be curtailed.

Embodiment 2

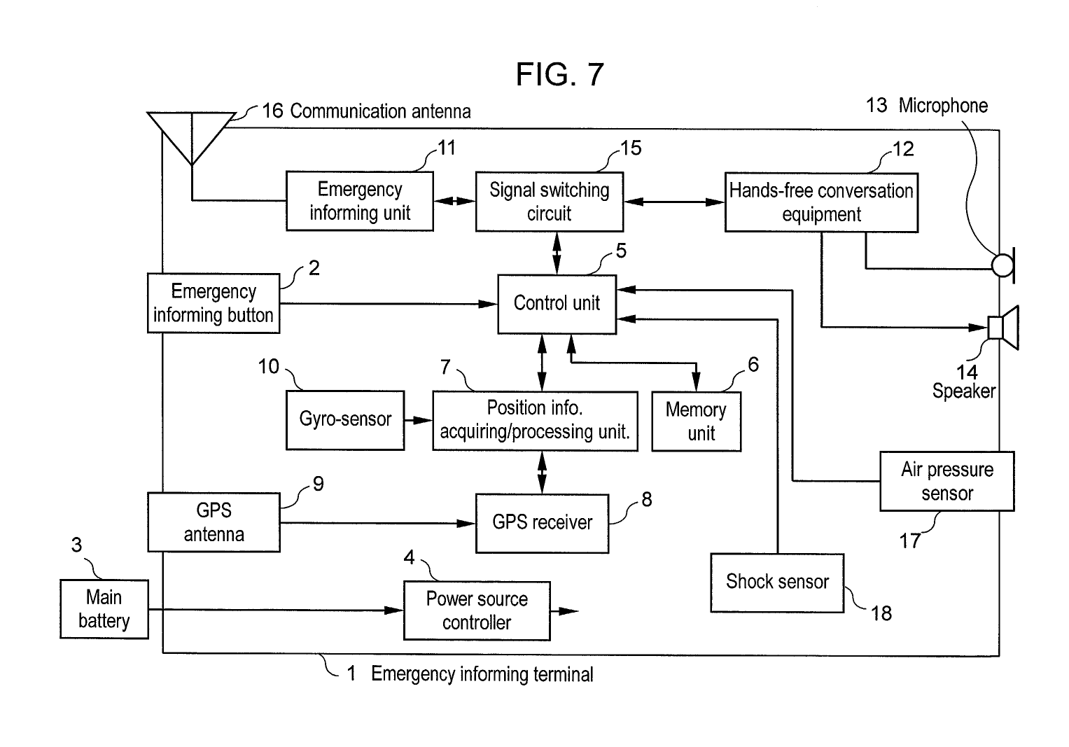

FIG. 7 is a block diagram showing a configuration of emergency informing terminal in embodiment 2 of the invention.

In this embodiment, the emergency informing terminal including an air pressure sensor and a shock sensor is explained.

The air pressure sensor is an example of air pressure measuring means for detecting elevation of air pressure when the air bag device is actuated to expand the air bag, and generating a signal showing an air pressure change.

The shock sensor is an example of shock detecting means for detecting a sudden shock of traffic accident or the like, and generating a signal showing application of shock.

What this embodiment differs from embodiment 1 is that the emergency informing terminal further incorporates sensors for generating a start signal for starting automatic emergency informing process such as an air pressure sensor and a shock sensor.

An air pressure sensor 17 detects a sudden change in air pressure due to expansion of the air bag or the like, and starts an automatic emergency call without pushing of the emergency informing button 2.

A shock sensor 18 detects fluctuations of acceleration. By detecting a sudden shock such as a traffic accident, the shock sensor 18 starts the automatic emergency call without pushing of the emergency informing button 2.

When the air bag is expanded due to a traffic accident or the like, the air bag instantly generates gas by chemical reaction or the like, and forms an air cushion.

The air pressure sensor 17 issues the information of air pressure detected periodically, or the air pressure change information by detecting a sudden rise of air pressure, to the control unit 5.

The control unit 5, when detecting a sudden air pressure change, judges that the air bag is expanded, and starts the emergency informing process.

As mentioned above, since the air pressure sensor 17 is incorporated in part of the emergency informing terminal 1, disconnection due to impact of accident is prevented, and the air pressure can be detected securely.

If an acceleration fluctuation or impact exceeding a specified value is applied due to a traffic accident or the like, the shock sensor 18 detects the shock, and issues shock detecting information to the control unit 5.

The control unit 5 judges that a shock exceeding a predetermined value is applied due to the accident, and starts the emergency informing process without pushing of the emergency informing button 2.

Since the shock sensor 18 is incorporated in part of the emergency informing terminal 1, disconnection due to impact of accident is prevented, and the shock can be detected securely.

Thus, by the detection signal of the air pressure sensor 17 or shock sensor 18, an accident is detected, and the emergency informing process is started securely. Simultaneous detection of air pressure and a shock is not always necessary, but by simultaneous monitoring, if either one is defective, occurrence of accident can be securely detected by the signal from the other one.

Further, by interlocking the air pressure elevation due to an expansion of air bag and the shock detection by the shock sensor, and starting informing process only when the both are actuated simultaneously, wrong notice due to trouble of either side may be prevented.

Although not shown in the drawings, the emergency informing terminal 1 may also incorporate the lighting device, display or indicator for transmitting the vehicle information to the user, such as the operating state of the emergency informing terminal 1, degree of impact of the accident, progress status of communication, radio wave reception status, or air bag operating state. As a result, disconnection due to impact of the accident is prevented, and the operating state can be displayed securely.

Thus, the emergency informing terminal of the embodiment incorporates sensors for generating the start signal for starting the automatic emergency informing process such as an air pressure sensor and a shock sensor in part of the emergency informing terminal. Thus, it is not necessary to connect the accident detecting means and the emergency informing terminal main body with connection wires. As a result, the reliability of the emergency informing terminal is enhanced, and the emergency call is processed securely. Moreover, the number of parts such as connection wires and connectors for connecting the peripheral devices such as an air pressure sensor and a shock sensor and the emergency informing terminal can be curtailed.

Meanwhile, all the peripheral devices are not always required in the emergency informing terminal. The object of the invention is achieved by selecting and installing at least one of these peripheral devices.

If a camera is incorporated in part of the emergency informing terminal, and the compartment image is taken and transmitted to the center, the accident image can be obtained at the center, and the same effects as mentioned above are also obtained.

The emergency informing terminal of the invention incorporates peripheral devices such as a microphone and a speaker used in hands-free conversation, an emergency informing button, a GPS antenna, and a communication antenna inside or in part of the emergency informing terminal.

Therefore, as clear from the explanation herein, it is not necessary to connect the main body of the emergency informing terminal and the peripheral devices with connection wires. As a result, the reliability of the emergency informing terminal is enhanced, and emergency call is processed securely. Moreover, the number of parts such as connection wires and connectors for connecting the peripheral devices and the emergency informing terminal can be curtailed.

Further, the emergency informing terminal incorporates sensors for generating the start signal for starting the automatic emergency informing process such as an air pressure sensor and a shock sensor. Thus, it is not necessary to connect the peripheral devices with connection wires, the reliability of the emergency informing terminal is enhanced, and the emergency call is processed securely. Moreover, the number of parts such as connection wires and connectors for connecting the peripheral devices and the emergency informing terminal can be curtailed.

Still more, since the communication antenna and GPS antenna are not installed outside of the vehicle, theft and other crime can be prevented.

All peripheral devices are installed in the vehicle, and are not exposed to rain or storm, and the service life of the devices is extended.

The installation work of the gyro sensor and communication antenna, which was hitherto complicated and difficult, is very much simplified.

This emergency informing terminal is portable, and when buying a new car, the emergency informing terminal can be easily removed and installed. The installation work is very simple.

What is claimed is:

1. An emergency informing terminal mounted on a vehicle for making an emergency call to an emergency call center in case of emergency, comprising:
a terminal main body, and a peripheral device connected to the terminal main body and incorporated in part of the terminal main body.

2. The emergency informing terminal of claim 1, wherein said peripheral device is a microphone for acquiring a transmission voice signal for hands-free conversation.

3. The emergency informing terminal of claim 1, wherein said peripheral device is a speaker for sounding a reception voice signal for hands-free conversation.

4. The emergency informing terminal of claim 1, wherein said peripheral device is a communication antenna for processing at least one of data communication and conversation, between the emergency informing terminal and the emergency call center.

5. The emergency informing terminal of claims 1 or 4, wherein said peripheral device is a primary antenna used in a transmission and reception process.

6. The emergency informing terminal of claims 1 or 4, wherein said peripheral device is a secondary antenna used in reception process.

7. The emergency informing terminal of claim 1, wherein said peripheral device is a lighting device, display, or indicator for transmitting an operating state of the emergency informing terminal to the user.

8. The emergency informing terminal of claim 1, wherein said peripheral device is an emergency informing button to start an emergency informing process as being pressed by an user in case of emergency.

9. The emergency informing terminal of claim 1, wherein said peripheral device is a dial operation unit for making a telephone call to a desired telephone number.

10. The emergency informing terminal of claim 1, wherein said peripheral device is a shock sensor for generating a signal showing application of a shock.

11. The emergency informing terminal of claim 1, wherein said peripheral device is an air pressure sensor for generating a signal showing an air pressure change.

12. The emergency informing terminal of claim 1, wherein said peripheral device is a GPS antenna for acquiring a signal from a GPS satellite.

13. The emergency informing terminal of claim 1, wherein said peripheral device is a gyro sensor.

14. An emergency informing terminal comprising:
a) a terminal main body, and
b) a peripheral device connected to the terminal main body and incorporated in part of the terminal main body including at least one of
voice signal transmitting means for hands-free conversation,
radio communication signal transmitting means for making radio communications between the emergency informing terminal and the emergency call center,
display means for transmitting an operating state of the emergency informing terminal to a user,
emergency informing means for starting emergency informing process,
dial operation means for making a telephone call, shock detecting means for generating a signal showing application of a shock,
air pressure measuring means for generating a signal showing an air pressure change, and
position information acquiring means for acquiring position information from a satellite.

15. An emergency informing system comprising:
a) an emergency call center; and
b) an emergency informing terminal mounted on a vehicle for making an emergency call to an emergency call center in case of emergency,
wherein said emergency informing terminal includes,
a terminal main body, and
a peripheral device connected to the terminal main body and incorporated in part of the terminal main body.

16. The emergency informing system of claim15,
wherein said peripheral device is a microphone for acquiring a transmission voice signal for hands-free conversation.

17. The emergency informing system of claim15,
wherein said peripheral device is a speaker for sounding a reception voice signal for hands-free conversation.

18. The emergency informing system of claim15,
wherein said peripheral device is a communication antenna for processing at least one of data communication and conversation, between the emergency informing terminal and the emergency call center.

19. The emergency informing system of claim15 or 18,
wherein said peripheral device is a primary antenna used in a transmission and reception process.

20. The emergency informing system of claim15 or 19,
wherein said peripheral device is a secondary antenna used in reception process.

21. The emergency informing system of claim15,
wherein said peripheral device is a lighting device, display, or indicator for transmitting an operating state of the emergency informing terminal to the user.

22. The emergency informing system of claim15,
wherein said peripheral device is an emergency informing button to start an emergency informing process as being pressed by an user in case of emergency.

23. The emergency informing system of claim15,
wherein said peripheral device is a dial operation unit for making a telephone call to a desired telephone number.

24. The emergency informing system of claim15,
wherein said peripheral device is a shock sensor for generating a signal showing application of a shock.

25. The emergency informing system of claim15,
wherein said peripheral device is an air pressure sensor for generating a signal showing an air pressure change.

26. The emergency informing system of claim15,
wherein said peripheral device is a GPS antenna for acquiring a signal from a GPS satellite.

27. The emergency informing system of claim15,
wherein said peripheral device is a gyro sensor.

28. The emergency informing system comprising:
a) an emergency call center; and
b) an emergency informing terminal mounted on a vehicle for making an emergency call to an emergency call center in case of emergency,
wherein said emergency informing terminal includes,
i) a terminal main body, and
ii) a peripheral device connected to the terminal main body and incorporated in part of the terminal main body including at least one of voice signal transmitting means for hands-free conversation,
voice signal transmitting means for hands-free conversation,
radio communication signal transmitting means for making radio communications between the emergency informing terminal and the emergency call center,
display means for transmitting an operating state of the emergency informing terminal to a user,
emergency informing means for starting emergency informing process,
dial operation means for making a telephone call,
shock detecting means for generating a signal showing application of a shock,
air pressure measuring means for generating a signal showing an air pressure change, and
position information acquiring means for acquiring position information from a satellite.
